(19) United States
(12) Patent Application Publication
(10) Pub. No.: US 2021/0201928 A1
(43) Pub. Date: Jul. 1, 2021

(54) INTEGRATED SPEECH ENHANCEMENT FOR VOICE TRIGGER APPLICATION

(71) Applicant: Knowles Electronics, LLC, Itasca, IL (US)

(72) Inventors: Harsha Rao, Campbell, CA (US); Anil Jakkam, Mountain View, CA (US); Pratik Shah, Milpitas, CA (US); Stephen Cradock, San Francisco, CA (US); Sharon Gadonniex, Arlington, MA (US); Tianfang Liu, Santa Clara, CA (US)

(21) Appl. No.: 17/128,172

(22) Filed: Dec. 20, 2020

Related U.S. Application Data
(60) Provisional application No. 62/955,943, filed on Dec. 31, 2019.

(51) Int. Cl. G10L 21/0232; G10L 21/0224; G10L 15/06; G10L 15/22

(52) U.S. Cl. CPC G10L 21/0232; G10L 21/0224; G10L 2021/02082; G10L 15/22; G10L 15/063

(57) ABSTRACT

Systems and methods are disclosed for processing audio for an electronic device, the electronic device including an integrated speech enhanced voice trigger module that can provide an improvement over existing voice trigger modules by effectively combining together voice trigger techniques and speech enhancement techniques. In various embodiments, the integrated speech enhanced voice trigger module is configured to reduce mismatches in types and levels of noise that are encountered during both voice trigger training and runtime. This can result in a higher true positive rate (TPR), a lower false alarm (FA), and a lower impostor acceptance rate (IAR). The disclosed integrated speech enhanced voice trigger module can be used be used with an electronic device having a single microphone or a plurality of microphones.

### TECHNICAL FIELD

The present embodiments relate generally to the field of audio processing and more particularly to speech enhancement techniques for voice or speech recognition in electronic devices.

### BACKGROUND

Voice trigger techniques are used in many applications and electronic devices which support keyword and/or speech recognition. Examples of such devices include cell phones, car infotainment systems, and smart home and office devices, such as smart speakers, smart TVs, video gaming stations, and more. Some specific examples of such devices include iPhone, Amazon Echo and Echo Dot.

In a typical voice trigger technique, an electronic device is responsive to a voice identifier (ID) keyword or keywords spoken by a user. Typically, upon detecting the VID keywords spoken by the user, the device enters a particular mode in which it can take further voice commands from the user. For example, when a user speaks “Hey Siri” into an iPhone, the iPhone can be considered to enter a “wake” mode. While in the wake mode, the iPhone can take further commands from the user, for example “call Home”, “How is the weather today?”, or more.

In general, before receiving a VID keyword, the electronic device may operate in a “normal” or a “low power mode” and after receiving the VID keywords it can enter a “wake” or a “high power mode” in which it can receive further voice commands to take specific actions.

The VID keywords can be either generic or user trained. Generic keywords are typically defined by original equipment manufacturers (OEMs). Some examples of generic VID keywords are “Hey Google”, “Hey Siri”, and “Alexa”. User trained keywords can be any custom keywords decided by the user. As can be appreciated, the OEM keyword are typically speaker (user) independent whereas user trained keywords are typically speaker (user) dependent.

In order to implement VID keyword detection, an electronic device typically includes a keyword model for detecting the VID keywords. The keywords to be detected are used to train the keyword models. The training can be performed offline or online. Generally speaking the training for OEM keywords is performed offline and the training for user trained keywords is performed online.

Meanwhile, many speech enhancement techniques are also commonly used in such electronic devices, such as noise suppression, echo cancellation, etc. However, there remains a need for an effective way to integrate such speech enhancement techniques with voice trigger techniques.

### SUMMARY

Systems and methods are disclosed for an integrated speech enhanced voice trigger module. The keyword models trained by the disclosed embodiments are optimized for performing in the presence of speech enhancement techniques. The disclosed voice trigger module can be part of an audio processing system and can be used in a single microphone or a multi-microphone configuration for receiving speech data.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates an environment including an electronic device in which an integrated speech enhanced voice trigger module disclosed herein may be used, according to an exemplary embodiment.

FIG. 2 illustrates a typical example block diagram of a voice trigger module included in the electronic device of FIG. 1.

FIG. 3 is a block diagram illustrating a first example of an existing voice trigger module for a single channel.

FIG. 4 is a block diagram illustrating a second example of an existing voice trigger module for a single channel.

FIG. 5 is a block diagram illustrating a first example of an integrated speech enhanced voice trigger module according to an embodiment.

FIG. 6 is a block diagram illustrating a second example of an integrated speech enhanced voice trigger module for multiple channels, according to an embodiment.

FIG. 7 is a block diagram illustrating a third example of an integrated speech enhanced voice trigger module according to an embodiment.

FIG. 8 illustrates a first example plot of signal to noise ratio versus true positive rate for various voice trigger modules, according to an example embodiment.

[symbol]

FIG. 9 illustrates an example flow diagram for an integrated speech enhanced voice trigger module, according to an example embodiment.

### DETAILED DESCRIPTION

According to certain general aspects, the disclosed embodiments are directed to an integrated speech enhanced voice trigger module that can provide an improvement over existing voice trigger modules by effectively combining together voice trigger techniques and speech enhancement techniques.

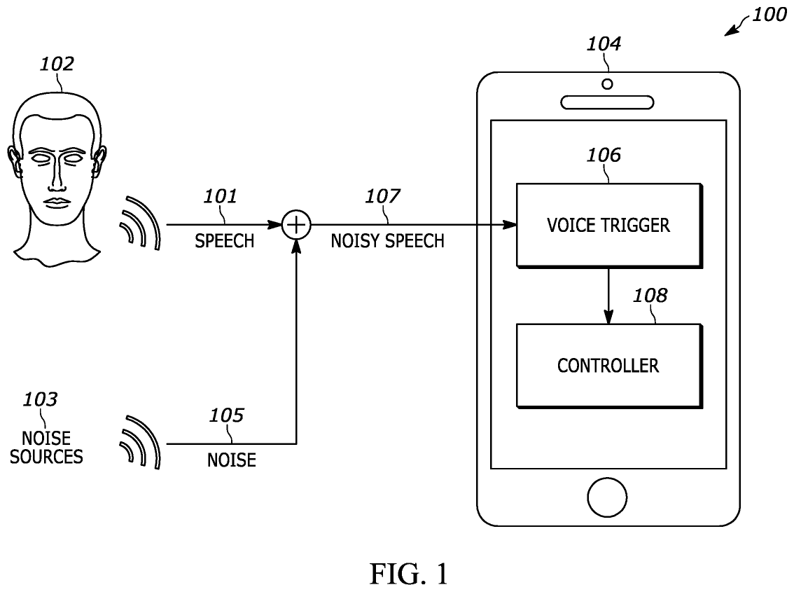

FIG. 1 illustrates an example environment 100 in which an integrated speech enhanced voice trigger module disclosed herein may be used, according to an exemplary embodiment.

As shown, the environment 100 includes at least one a user 102 which is speaking into an electronic device 104 that has a voice wake or a voice trigger capability. In the example shown the electronic device 104 is a cell phone (i.e. smart phone) but in other examples, it can be any device such as a smart home or office system, a smart TV remote or any other device which is capable of speech recognition.

As shown, user 102 is delivering clean speech 101 to the electronic device 104. The environment 100 also includes other sounds collectively referred to as noise sources 103, which may include other humans or animals making sounds, such as other people in conversation, kids playing, laughing or crying, or pets making sounds, music and/or sound media (e.g., sound track of a film), transient event sounds (e.g., sounds from humans in the environment handling metal objects or aluminum cans, chopping food, dropping a plate or glass, etc.), and/or ambient environment sounds. The ambient environment sounds can include sounds which can be further broken down into different specific categories such as ambient or background noise (e.g., machine buzzing or humming, air conditioner sound, washing machine swirling, etc.), repetitive sounds (e.g., hammering, construction sound, ball bouncing, etc.), obtrusive noise (e.g., vacuum, coffee grinder, food processor, garbage disposal, drill, etc.), or attention-seeking sounds (e.g., ringers, horns, alarms, sirens, etc.). Noise sources 103 can also include acoustic echo, such as sounds captured by microphones on the device that are generated by a loudspeaker (either on the device or remotely located from the device).

Noise 105 may represent any of the above mentioned sounds generated by the noise sources 103. It may be apparent that the noise 105 gets mixed with the clean speech 103 to form a noisy speech signal 107 that is received by the electronic device 104.

The electronic device 104 may include a voice trigger module 106 and a controller 108. In general, the voice trigger module 106 detects keywords and the controller 108 takes action based on the detections. Both the voice trigger module 106 and the controller 108 can be implemented in software or hardware or any combination thereof. Although shown separately for ease of illustration, they may be implemented either partially or completely together in a single component. It may be appreciated by those skilled in the art that the electronic device 104 may include many other components and functions which are not shown as those are not relevant to the current specification.

The speech 101 can include a single keyword or a plurality of keywords, which if correctly detected from the noisy speech signal 107 by voice trigger 106, can be used by controller 108 to cause the electronic device 104 to enter a “wake mode”. Further, in the “wake mode” the electronic device 104 can take further control actions in response to commands. Some example commands for actions can include “play music”, “find a specific address”, “call someone” or more. Although the present embodiments will be described below mainly in connection with an example where voice trigger 106 is responsive to a predefined generic keyword, the embodiments are not limited thereto. In other examples, the keyword can be user trained.

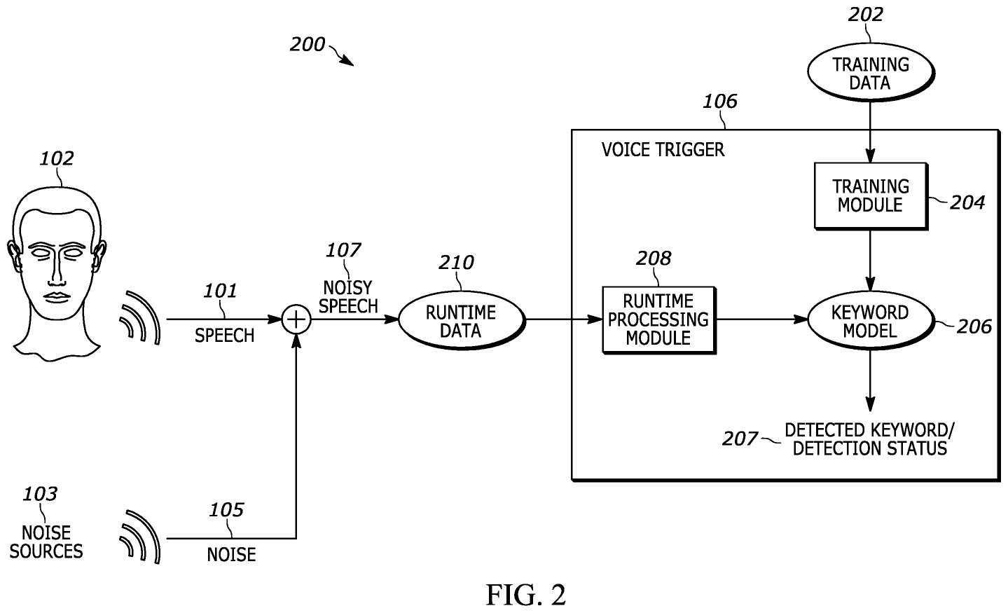

FIG. 2 is a functional block diagram illustrating certain example aspects of one possible voice trigger module 106 included in the environment 100 of FIG. 1. More exemplary details of the voice trigger module 106 are also shown in FIG. 2. As shown, the voice trigger module 106 comprises a training module 204, a runtime processing module 208, and a keyword model 206. The voice trigger module 106 is configured to receive runtime data 210 during runtime and training data 202 during training. The keyword model 206 is configured by training module 204 during a training mode and is operable to work with the runtime processing module 208 to detect a keyword and further output a detection status during a runtime mode. Voice trigger module 106 may be implemented using a processor such as a CPU or DSP and associated firmware or software. In these and other embodiments, it may be implemented in a FPGA or ASIC. Moreover, voice trigger module 106 may be implemented as a standalone component. Alternatively, voice trigger module 106 may be implemented in an audio processor or similar component, perhaps together with other audio processing functionality.

During a training stage, the training module 204 typically creates or adapts keyword model 206 by extracting certain features from training data 202, which comprises speech segments containing a keyword or phrase to be detected. This keyword can be a predefined generic keyword such as “ ” or another word or phrase. The speech segments can be recorded speech segments or live speech segments. Training module 204 uses the extracted features from training data 202 to configure the coefficients of the keyword model 206 in an iterative process until the keyword model 206 is able to successfully detect the presence of the keyword above a threshold level of accuracy (e.g. measured in terms of a “true positive rate” or other criteria).

During runtime, voice trigger 106 receives and operates on runtime data 210, which as shown in FIG. 2 can include noisy speech 107. Runtime processing module 208 extracts features from runtime data, which are preferably the same features extracted from training data 202 by training module 204, and provides the extracted features to keyword model 206. As such, if noisy speech 107 (i.e. speech 101 from a user mixed with noise 105 from noise sources 103) contains the keyword or the phrase, then the keyword model 206 outputs a detection status indicating that the keyword was detected. Voice trigger 106 can then generate a detection status signal 207 as an output.

The detection status may give a positive or a negative indication. Some examples of positive indications can be “detected” or “successful” or “yes”. Some examples of negative indications can be “not detected” or “not successful”, or “no”. In some examples, the detection status can also indicate a probability of detection which may be in the range of zero to one hundred percent, for example.

As explained earlier, for generic keywords that are predefined by OEMs, the training process is usually performed offline by the OEMs. For user trained keywords, the training process is usually done online. As may be appreciated, in an offline training process, the training data is offline and in an online training process, the training data 202 can also be part of the runtime data 210. In some examples, the training process can be a combination of both offline and online processes. It should be noted that the process flow of the voice trigger module 106 as shown in FIG. 2 is exemplary. As will be evident from the following paragraphs, alternative embodiments may comprise more modules, fewer modules, or equivalent modules and still be within the scope of embodiments of the present technology.

According to some aspects, the present applicant has discovered certain problems that afflict many audio electronic devices that perform voice trigger techniques. For example, during training, the keyword model is exposed to the desired VID keywords as clean speech signals mixed with separate noise signals, whereas during runtime, the same VID keywords are mixed with ambient noise signals. There can be a mismatch between the types and levels of noise that are used during training and the types and levels of noise that are received during runtime. This mismatch can result in an ineffective training of the keyword models which may lead to inaccurate detection of the keywords.

This issue can become even more problematic when noise suppression or speech enhancement is used during runtime, as is becoming more commonplace in devices also having voice trigger applications. For example, during training, the keyword models are generated/configured using mixed speech/noise signals that have not been processed with noise suppression or speech enhancement. On the other hand, during runtime, the signals are typically noise suppressed before being provided to the keyword model. This can further increase the mismatch between the noise levels of the speech used during training and the speech processed during runtime which may reduce the performance of the keyword detection process.

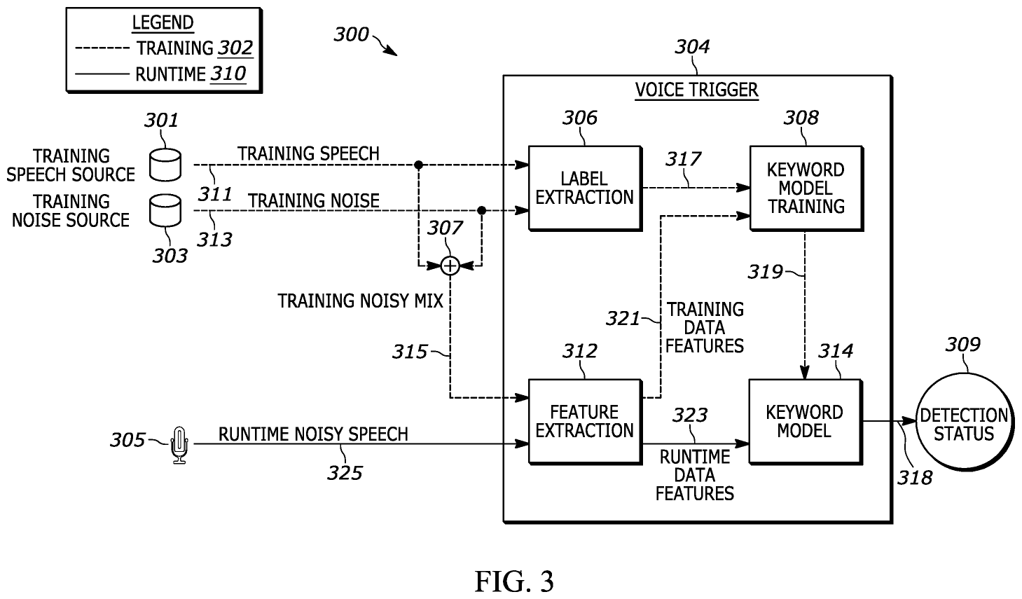

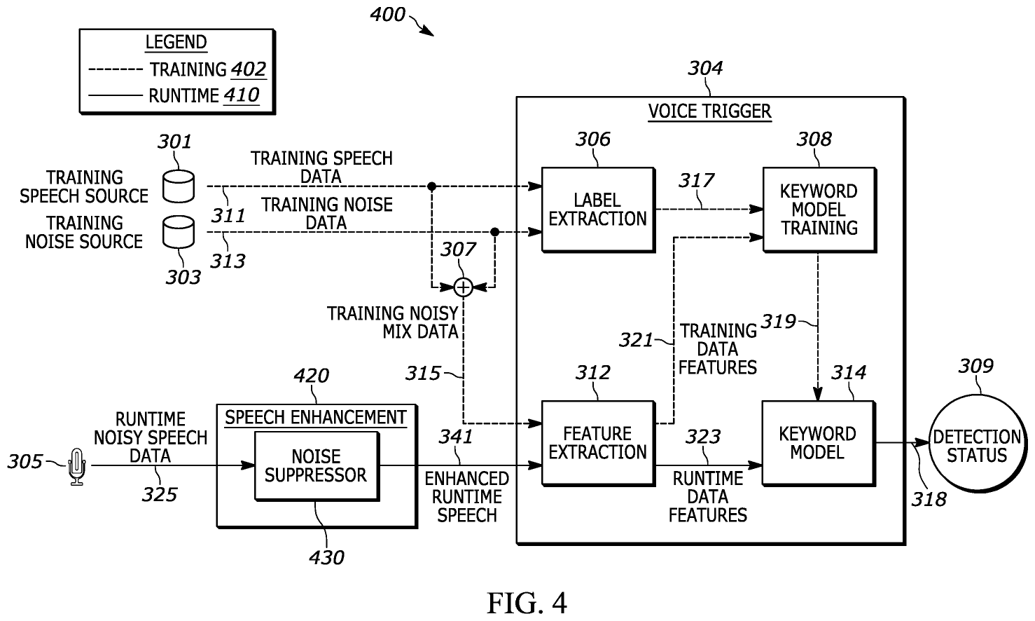

These and other aspects will now be described in connection with FIG. 3 and FIG. 4.

FIG. 3 is a block diagram illustrating an example configuration 300 including an existing type of voice trigger module 304. The voice trigger module 304 is operable to work with an training stage 302 (indicated by dashed lines) as well as an runtime stage 310 (indicated by solid lines). As can be seen in FIG. 3 in the example configuration 300, both the training stage 302 (sometimes referred to as an offline training stage, an online training stage or an offline/online training stage) and the runtime stage 310 (sometimes referred to as an online/deployment stage) share some common blocks including a label extraction block 306, a keyword model training block 308, a feature extraction block 312, and a keyword model 314.

With reference to FIGS. 2 and 3, the voice trigger module 304 can be considered an example of voice trigger module 106 shown in FIG. 2. An example of a voice trigger module that can be used in embodiments is described in U.S. Pat. No. 9,830,080, the contents of which are incorporated by reference herein in their entirety. The training speech data (hereafter training speech) 311 and the training noise data (hereafter training noise) 313 together can be an example of the training data 202 in FIG. 2. Similarly, the runtime noisy speech data (hereafter runtime noisy speech) 325 is analogous to the runtime data 210 in FIG. 2. The training stage 302 may be part of the training module 204 in FIG. 2 and the runtime stage 310 may be part of the runtime processing module 208 in FIG. 2. It may be understood that the training speech data 311, the training noise 313, and the runtime noisy speech 325 all comprise audio signals.

As shown, the training stage 302 further includes a training speech source 301 and a training noise source 303 and generates training noisy mix data (hereafter training noisy mix) 315 of the two via a signal mixer 307. In one example, the training speech source 301 is a database of recorded speech segments and the training noise source 303 is a database of recorded noise. In another example, including if the training is implemented online, then the training speech source 301 and training noise source 303 can also be a microphone integrated in the electronic device 104. In other examples, the microphone 301 can be a separate microphone.

The runtime stage 310 is configured to generate a runtime noisy speech signal 325 via a microphone 305, which in one embodiment can be a microphone integrated in the electronic device. With reference to FIG. 2, the microphone 305 is configured to receive the speech 101 by the user 102 and the noise 105 from the noise sources 103 and generate the noisy speech signal 325 in response. The configuration 300 can be referred to as a single channel configuration comprising a single microphone 305.

The label extraction block 306 and the feature extraction block 312 are configured to extract certain information from the training speech 311 and the training noise 313 during the training stage 302. In general, label extraction is a process in which an identifier (e.g. speech, noise, etc.) is generated specific to an audio signal. The feature extraction is a process in which certain time domain or frequency domain features are extracted from an audio signal. Time domain features typically include energy of the audio signal, zero crossing rate, maximum amplitude, and minimum energy of the audio signal. Frequency domain features typically include fundamental frequency, frequency components, spectral centroid, spectral flux, spectral density, spectral roll-off, etc. Spatial features such as inter-mic time differences (ITD), inter-mic phase differences (IPD), inter-mic level differences (ILD) are also available when using multi-microphones. The keyword model training block 308 is configured to train the keyword model 314 based on the extracted features. During the runtime stage 310, the same features may be extracted from the noisy speech 325 and provided to the keyword model 314. The keyword model 314 is configured to output a detection status 309 based on the extracted features.

As set forth above, the present applicant has recognized that even if there is no noise suppression or speech enhancement performed on either the training noisy mix 315 or the runtime noisy speech 325, the types and levels of noise in the training noisy mix 315 and the runtime noisy speech 325 may be substantially different (i.e. may exhibit a mismatch), which may lead to ineffective keyword detection during runtime.

FIG. 4 is a block diagram illustrating another example configuration 400 including the existing type of voice trigger module 304 of FIG. 3. The configuration 400 also includes a speech enhancement module 420 which can include a noise suppressor 430. In one example, the noise suppressor 430 can be a mask based noise suppressor. In other examples, noise suppressor 420 can be designed using classical signal processing algorithms or data-driven, machine learning based algorithms. These and other noise suppressors can work on stationary and non-stationary noise sources. In some other examples, the speech enhancement module 420 may also include linear (e.g. AEC and beam-formers) or non-linear types of noise suppressors or echo suppressors. Beam-formers may be especially used in a multi-channel configuration for directional sensing of audio data coming from a plurality of microphones.

This type of configuration in which the speech enhancement module 420 is used as a front-end portion to the voice trigger module 304 may also be referred to as a cascaded configuration.

As shown, during the runtime stage 310, the noisy speech 325 is provided to the noise suppressor 430 which is configured to suppress the noise levels in the signal 325 and generate enhanced runtime speech 341. The feature extraction block 312 is configured to receive the enhanced (noise suppressed) runtime speech 341. However, the training noisy mix 315 does not pass through any noise suppressor, so the noise levels in the training noisy mix 315 are not suppressed. In other words, existing types of voice trigger modules are configured to train keyword models using training data that has not been speech enhanced. The training data (training speech 311 plus training noise 313) may have a lower signal to noise ratio (SNR) whereas the enhanced runtime speech 341 has a higher SNR. This leads to a substantial mismatch between the noise levels of the training noisy mix 315 and the enhanced runtime speech 341. This mismatch can lead to ineffective keyword detection (e.g. low TPR) during runtime when the voice trigger includes keyword models that were trained using data that was not speech enhanced. This mismatch can be made less severe if linear cancelers are used as part of the speech enhancement module 420. However, if the speech enhancement module 420 includes a non-linear canceller or a mask-based suppressor, then the noise level mismatch between training data and runtime data can be quite significant. This mismatch can limit the use of mask-based suppressors as a front-end for voice trigger modules. For example, linear cancellation (when it operates correctly of course) is perceptually less damaging to target speech. One well-known beamfomer is the MVDR (minimum variance distortion-less response) beamformer. As the name suggests, it operates to reduce noise power while trying to maintain a distortion-less response for target speech. Whereas this is not true for non-linear, mask based suppressors. These techniques are far more aggressive in their approach to removing noise. As a result, some amount of target speech damage (changes to the speech formant, frequency response, intelligibility, etc.) is inevitable.

Applicant further recognizes that in the existing types of voice trigger modules, keyword models are typically trained using only single channel data, even when an electronic device uses multiple microphones during runtime. Therefore, spatial features of the sound captured by multiple microphones are not usually accounted for when training keyword models, which can lead to further mismatches and decreased runtime performance when a voice trigger application is included in an electronic device with multiple microphones.

Accordingly, as will be explained in more detail below, an integrated speech-enhanced voice trigger module according to embodiments can reduce a noise level mismatch or an SNR mismatch between the training data and the runtime data, thereby improving the voice trigger performance. In this regard, it should be apparent to those of ordinary skill in the art that some standard performance factors for voice trigger modules include but are not limited to true positive rate (TPR), or false alarm (FA) or impostor acceptance rate (IAR). More specifically, the higher the TPR the better, the lower the FA and IAR, the better. As will be evident from the following descriptions, the disclosed embodiments can improve these factors and more specifically can help achieve a higher TPR, a lower FA, and/or a lower IAR. The disclosed embodiments further offer a greater flexibility to use linear echo cancellers, non-linear echo cancellers, mask based noise suppressors, echo suppressors to be used with the speech enhancement module.

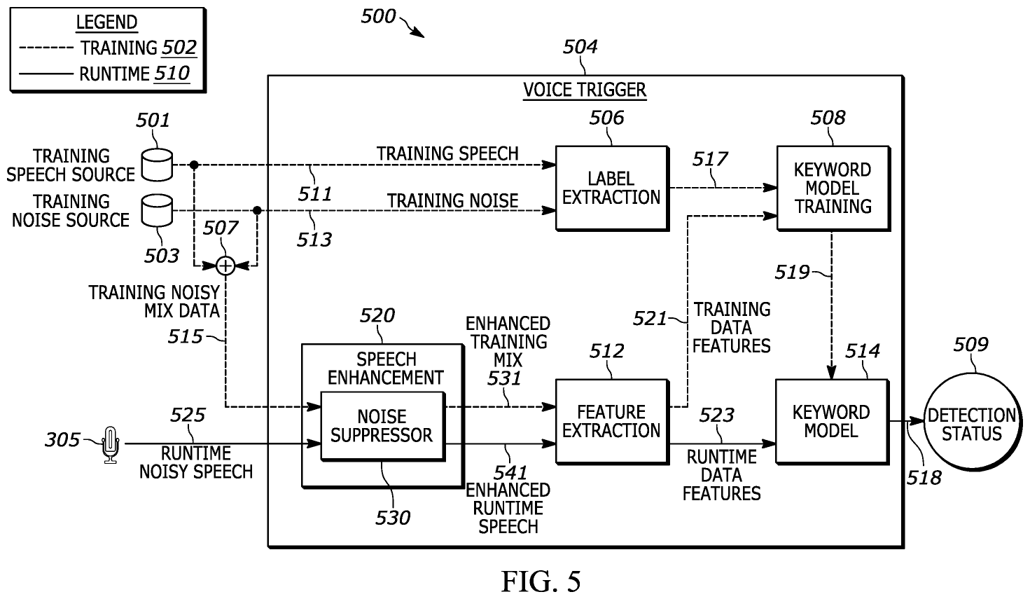

FIG. 5 is a block diagram illustrating an example configuration 500 including an integrated speech enhanced voice trigger module 504 according to an embodiment of the present disclosure. Also shown in FIG. 5 are a training stage 502, and a runtime stage 510. The configuration 500 may be referred to as a single channel configuration as it comprises only a single training speech source 501 and a single training noise source 503.

In the example shown in FIG. 5, the voice trigger module 504 shares many common inputs and outputs with the voice trigger module 304 in FIG. 3, including a training speech source 501, a training noise source 503, and a signal mixer 507, as well as detection status block 509. The voice trigger module 504 can also share many common stages and blocks with configuration 300 including label extraction block 506, keyword model training block 508, feature extraction block 512, and keyword model block 514. All of the above mentioned inputs, outputs, processes, and blocks can be configured in a manner similar to explained with respect to FIG. 3. However, ways in which voice trigger module 504 differs from the voice trigger module 304 in accordance with embodiments will be explained below.

Further similar to configuration 300 described above, the training data used during training 502 may be various combinations of training speech 511 and one or more separate noise signals 513 (e.g., background speech, music, highway noises similar to those described above). Training speech 511 is a clean speech signal without any noise comprising the keywords to be detected during runtime. During runtime stage 510, the runtime noisy speech 525 may or may not comprise the keywords to be detected.

However, voice trigger module 504 differs from voice trigger module 304 at least in that it further includes an integrated speech enhancement module 520 which can comprise a noise suppressor 530. The speech enhancement module 520 is configured to receive the runtime noisy speech 525 and generate an enhanced runtime speech 511. In contrast to the voice trigger modules 304 and 404, the speech enhancement module 520 is also configured to receive the training noisy mix 515 and generate an enhanced training mix 531. As may be appreciated, unlike the discrete noise suppressor 430 of FIG. 4, the integrated noise suppressor 530 is also configured to suppress the noise levels in the training noisy mix 515 during the training stage 502. In other words, it is configured to increase the SNR of the training noisy mix 515 in a similar manner as it increases the SNR of the runtime noisy speech 525.

Noise suppressor 530 can be a mask based noise suppressor, or any linear or non-linear noise suppressor known to those skilled in the art, and so further details thereof are unnecessary for an understanding of the present embodiments. Nevertheless, an aspect of the present embodiments is that it is included in speech enhancement module 520 that is integrated within module 504 and configured for use in both training stage 502 and runtime stage 510. As such, it is configured to generate enhanced training mix 531 from training noisy mix 515 during training, and to similarly generate enhanced runtime speech 541 from runtime noisy speech 525 during runtime.

In training stage 502, the training speech 511 which comprises clean speech data and training noise 513 are provided to the label extraction block 506. Initially in the label extraction block 506, audio mixtures of the training speech 511 and training noise 513 are formed and then labels are generated for those audio mixtures. Label extraction generally includes processing all the sounds in the audio mixture to identify and classify those sounds into different categories such as speech or noise etc.

In contrast to the feature extraction blocks 314 and 414, during training the feature extraction block 512 is configured to receive the enhanced training mix 531 and extract a plurality of training data features 521 therefrom, the enhanced training mix 531 being a speech-enhanced version of noisy training mix after noise suppression processing by module 520. The training data features 521 can include any known features such as temporal (time domain) features or spectral (frequency domain) features. Some examples of temporal features include the energy of signal, zero crossing rate, maximum amplitude, minimum energy, etc. Some examples of spectral features include fundamental frequency, frequency components, spectral centroid, spectral flux, spectral density, spectral roll-off, etc. The extracted training data features 521 are further provided to the keyword model training block 508 together with the labels 517.

In some embodiments, feature extraction block 512 may further generate model coefficients for the keyword model 514 to be trained. In these and other embodiments, those of ordinary skill in the art can appreciate that features such as Mel-frequency cepstral coefficients (MFCCs) can be used to generate keyword model coefficients.

The keyword model training block 508 is configured to train the keyword model 514 based on the extracted training data features 521 and labels 517. For example, when training is performed offline (e.g. by an OEM for a generic keyword), many dozens, hundreds or even thousands of mixtures of speech 511 and noise 513 may be used. Keyword model training block 508 is configured to receive the labels 517 associated with these mixtures, along with the features 521 extracted from the mixtures, and adjust the coefficients of keyword model 514 in an iterative process. The iterative process can be continued until the keyword model 514 is able to accurately detect the keyword using the extracted features 521 with a target level of performance (e.g. a target probability of false alarm). Some examples of VID keyword models that can be used in embodiments include Gaussian/Hidden Markov Models (GMM-HMM), deep neural networks (DNN), convolutional neural networks (CNN,) recurrent neural networks (RNN), and relational/convolutional neural networks (RCNN). Those skilled in the art will understand how such models can be trained using features such as those provided in the above examples.

Once the keyword model is trained, it may be provided for use in runtime stage 510. During the runtime stage 510, the same features that were extracted for the enhanced training mix 531 as described above may be extracted from the enhanced runtime speech 541 by feature extraction module 512 during runtime to generate runtime data features 523. These extracted runtime data features 523 are provided to the keyword model 514 for keyword detection. As can be appreciated, since both the training noisy mix 515 and the runtime noisy speech 525 pass through the same noise suppressor 530, the noise mismatch problem described above is substantially reduced. Hence, the training data features 521 extracted from the training noisy mix 515 can result in keyword model coefficients that are more likely to yield accurate keyword detections based on runtime data features 523 extracted during runtime. As such, the keyword or the phrase can be more accurately detected and a higher TPR may be achieved.

It should be noted that training can also be performed online and/or after a model has already been trained during an offline process (e.g. by an OEM). For example, an electronic device having voice trigger module 504 can store recordings of detected keywords or other speech segments that were captured during runtime, and these additional keywords or speech segments can be used by keyword model training 508 to further refine the keyword model 514 coefficients

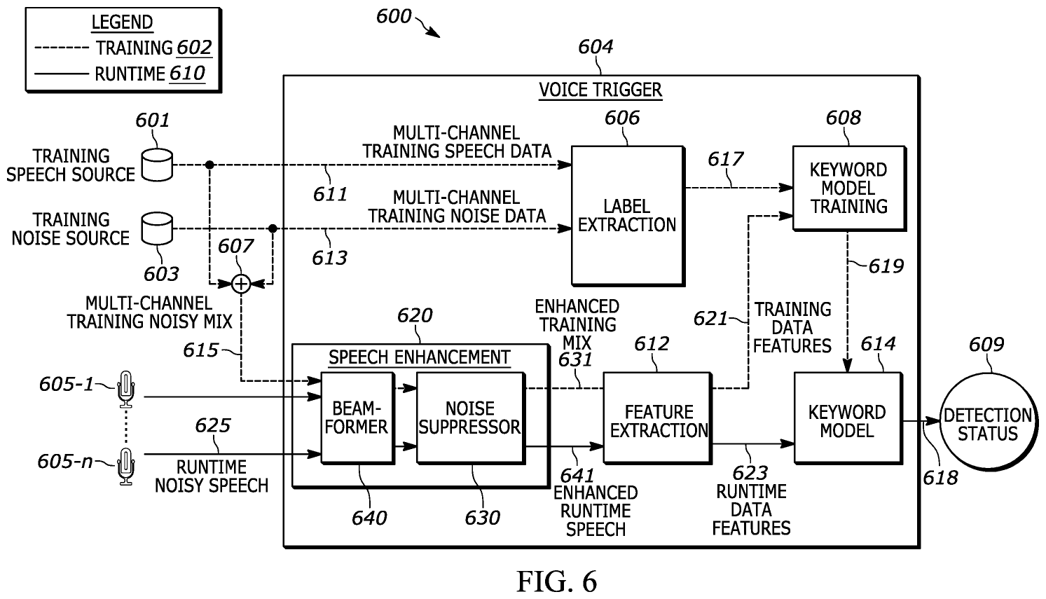

FIG. 6 is a block diagram illustrating an example configuration 600 including an integrated speech enhanced voice trigger module 604 for a plurality of channels, according to an embodiment of the present disclosure.

As shown, the training stage 602 includes a training speech source 601 and a training noise source 603. Differently from the preceding embodiment, training speech data 611 comprises speech data provided in two or more channels (e.g. speech segments simultaneously recorded from two or more spatially separated microphones) and training noise data 611 comprises noise data provided in two or more channels (e.g. noise simultaneously recorded from two or more spatially separated microphones). Similarly, the runtime noisy speech 625 in this configuration can be a combination of a plurality of channels of runtime speech from a plurality of microphones 605-1 to 605-n. The signal mixer 607 is configured to generate a multi-channel training noisy mix 615.

The configuration 600 also shares many common blocks/processes with the configuration 500, including the training stage 602, the runtime stage 610, the label extraction module 606, the keyword model training block 608, feature extraction block 612, and keyword model module 614 which can be implemented and function in a similar fashion as explained with respect to FIG. 5, except perhaps as detailed below.

Additionally, the speech enhancement module 620 comprises a noise suppressor 630 and a beam-former 640. The beam-former 640 is configured to receive the multi-channel training noisy mix 615 and the runtime noisy speech 625 and its output provided to the noise suppressor 630. Advantageously, the beam-former 640 is configured to apply directional sensing to both the multi-channel training noisy mix 615 and the runtime noisy speech 625. The noise suppressor 630 is configured to suppress the noise levels in the enhanced training mix 631, during the training stage 602 and suppress the noise levels in the enhanced runtime speech 641, during the runtime stage 610. In other examples the beam-former may be after the noise suppressor. In still further multiple-channel examples, speech enhancement module 620 may only comprise a beam-former 640.

Beam-former 640 can include adaptive or fixed beamforming techniques (e.g. by applying fixed or adaptive weights to signals received from respective microphones 605 or channels) and can be implemented using many techniques known to those skilled in that art. In any event, according to aspects of embodiments, since both the multi-channel training noisy mix 615 and the runtime noisy speech signal 625 are provided to the same beam-former 640 that it is integrated in voice trigger 604, the enhanced spatial characteristics of the resulting output signals during both training and runtime are accounted for.

Additionally, in these multiple channel embodiments, both training data features 621 and runtime data features 623 extracted by feature extraction block 612 can additionally or alternatively include phase differences between sound signals captured by the different microphones, magnitude differences between sound signals captured by the different microphones, respective microphone energies, etc. For individual sound signals from a given microphone, the signal features may include magnitude across a particular spectrum, modulations across a spectrum, frames of magnitude spectra, etc. In some embodiments, the signal features may be represented by, e.g., vectors. In additional or alternative embodiments, some or all of signal features can also be captured from the time-domain signals.

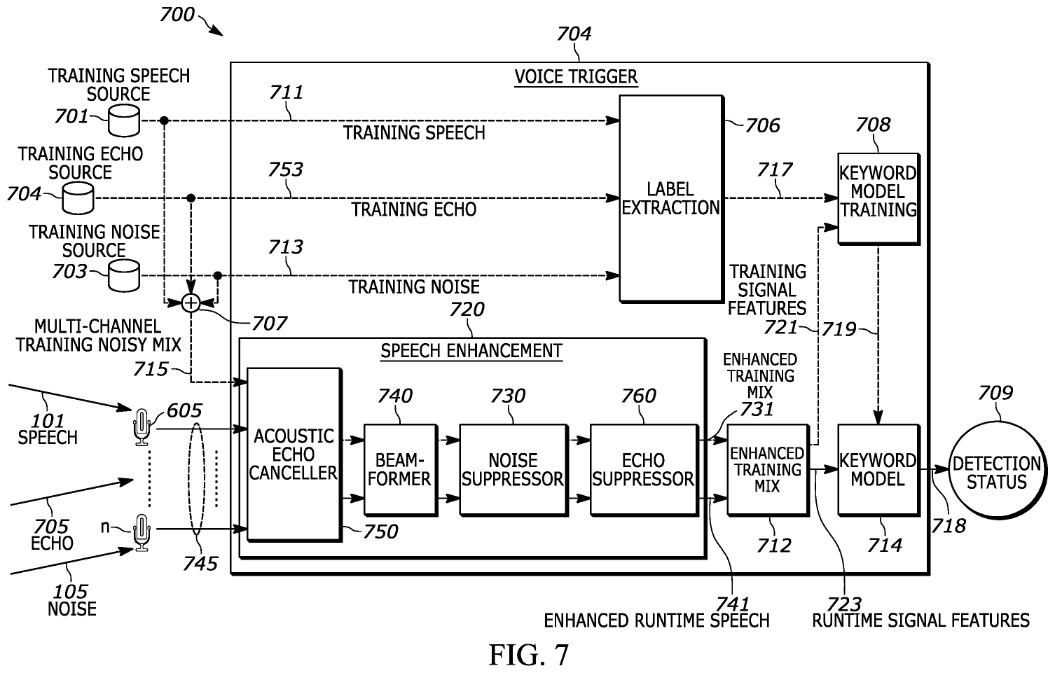

FIG. 7 is a block diagram illustrating an example configuration 700 including an integrated speech enhanced voice trigger module 704, for a plurality of channels and an echo source, according to an embodiment of the present disclosure.

The configuration 700 shares many common inputs with the configuration 600 including training speech source 701 for providing multi-channel training speech 711 and training noise source 703 for providing multi-channel training noise 713. Additionally, the configuration 700 includes a training echo source 751 and a runtime echo source 761. The voice trigger module 704 is configured to receive training echo data 753 from the training echo source 751 and runtime echo 705. As such, the multi-channel training noisy mix 715 also includes the training echo data 753 and the multi-channel runtime noisy mix 745 also includes echo. The source of the echo 705 in one example is a speaker (e.g. a loudspeaker of the electronic device including voice trigger module 704). However, in other examples, the echo source can be any other device or object which can generate an echo. The number of microphones and the number of speakers may be decided per design considerations.

The configuration 700 also shares many blocks/processes with the configuration 600 including training stage 702, a runtime stage 710, a label extraction module 706, a keyword model training block 708, a feature extraction block 712, and a keyword model module 714 which can be implemented similarly as explained with respect to FIG. 5.

Additionally, the speech enhancement module 720 comprises an acoustic echo canceller 750, a noise suppressor 730, a beam-former 740, and an echo suppressor 760. The acoustic echo canceller 750 can be a liner or a non-liner canceller, and can be implemented in many ways known to those skilled in the art. Noise suppressor 730 and beam-former 740 can be implemented similarly as described in FIGS. 5 and 6.

In one example, the acoustic echo canceller 750 is configured to receive the noisy runtime speech 745 during runtime and the multi-channel training noisy mix 715 during training and provide an output to the beam-former 740, which further provides an output to the noise suppressor 730, which in turn provides an output to the echo suppressor 760. The output of the echo suppressor 760 is provided to the feature extraction block 712. In other examples, the above mentioned acoustic echo canceller, the beam-former, the noise suppressor, and the echo suppressor may be configured in any order.

As may be appreciated by those skilled in the art that in this configuration, the acoustic echo canceller 750 is configured to cancel the runtime echo 705 from the noisy runtime speech 745, as well as the training echo 753 from the multi-channel training noisy mix 715. The beam-former 740 is configured to apply beamforming to the plurality of microphones 705 during runtime well as to the various channels in the noisy mix 715. The noise suppressor 730 is configured to suppress the noise levels in the noisy runtime speech 745, as well as the noisy mix 715. Lastly, the echo suppressor 760 may be configured to further suppress any remaining portion of the echo 705 from the noisy runtime speech 745, as well as any remaining portion of the echo 753 from the noisy mix 715.

As such the integrated speech enhancement module 720 applies echo cancellation, directional sensing, noise suppression, and echo suppression to the noisy mix 715 during training; and to the noisy runtime speech 745 during the runtime stage 710. Since both the noisy mix 715 and the noisy runtime speech 725 is provided to the same acoustic echo canceler 750 that is integrated in voice trigger 704, any noise mismatch due to echo is reduced by the present embodiments.

It may be thus appreciated that the integrated multi-channel speech enhanced voice trigger modules 504, 604 and 704 can be more effective in keyword detection and can give a better voice trigger performance.

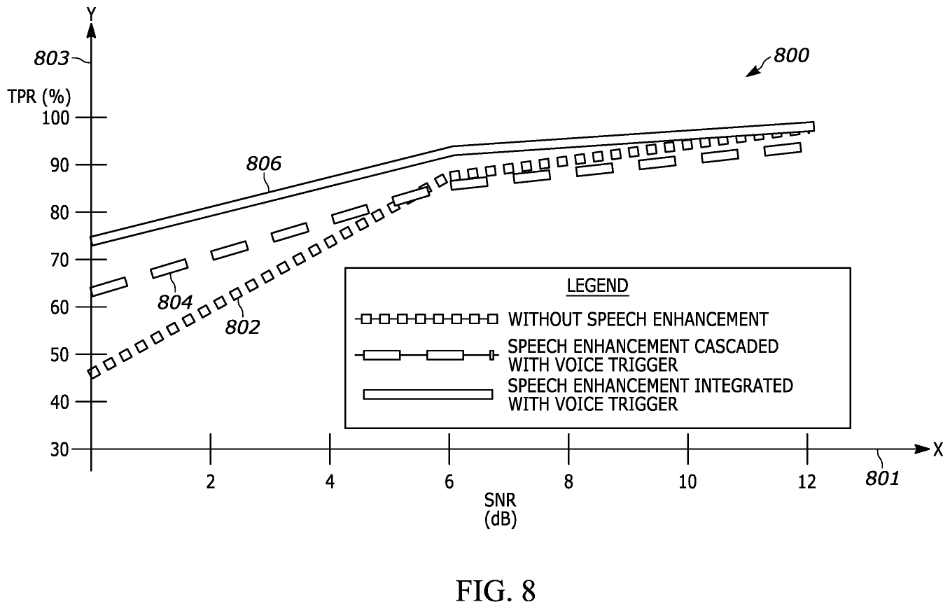

FIG. 8 illustrates example plots 800 of signal to noise ratio versus a true positive rate for various voice trigger modules, according to an example embodiment. The example plots are results of actual experiments.

As shown the X axis 801 represents the SNR in decibels and the Y axis 803 represents a true positive rate. A true positive rate (TPR) is a measure of the performance of a voice trigger module. In one example, the range of SNR is zero to twelve decibels. The TPR is shown in percentage. Curve 802 represents a TPR plot for a voice trigger module without any speech enhancement, for example the one shown in FIG. 3. Curve 804 represents a TPR plot for a cascaded speech enhanced voice trigger module and a noise suppressor, for example the one shown in FIG. 4. Curve 806 represents a TPR plot for an integrated speech enhanced voice trigger module, for example the one shown in FIGS. 5, 6 or FIG. 7.

As can be seen, the TPR value is higher for the cascaded voice trigger module than for the non-speech enhanced voice trigger module until the SNR is almost 6 dB but after that, the TPR value lowers compared to the non-speech enhanced module. In contrast to that the TPR value is higher for the integrated speech enhanced voice trigger module throughout the entire range of the SNR than for the cascaded speech enhancement voice trigger module or for the non-speech enhanced voice trigger module, and especially at lower SNRs. This illustrates some of the detrimental effects of mask-based noise suppressors. While it can help in low SNR, it can also damage speech. And this damage being more visible in high SNR has a direct impact on TPR.

[symbol]

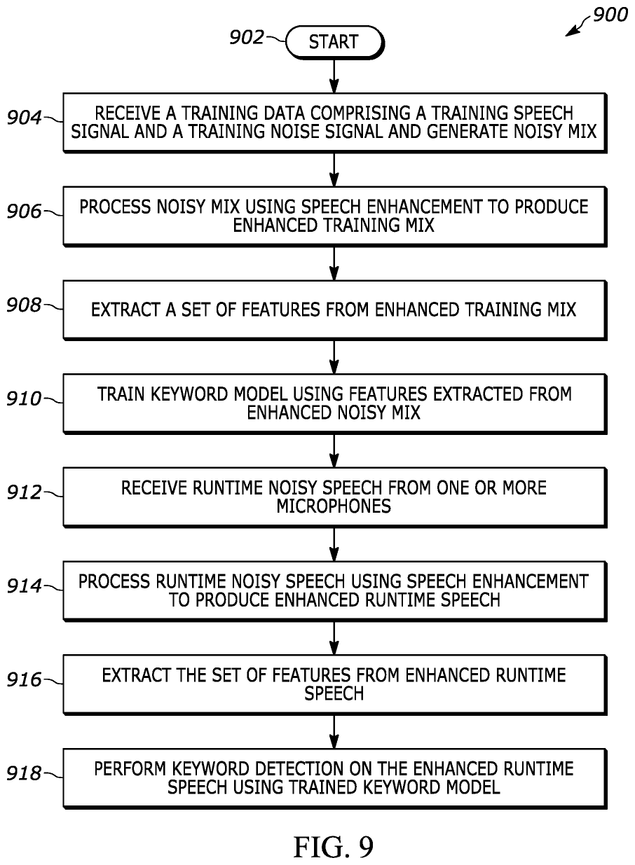

FIG. 9 is a flow diagram illustrating an example process 900 for the integrated speech enhanced voice trigger module as shown in FIG. 5 or FIG. 6 or FIG. 7, according to an example embodiment.

After starting at block 902, the process proceeds to block 904 where training data comprising a training speech signal and a training noise signal may be received by the voice trigger module. For example, in FIG. 5, the training speech signal 511 and the training noise signal 513 are received for the training speech source 501 and the training noise source 503 respectively. The training speech may include a keyword to be detected. The training speech signal and the training noise signal may be combined to generate a training noisy mix, similar to the noisy mix 515. In an OEM example, the training speech signal and the training noise signal can be different sets of sound files with recorded speech (e.g., included a generic keyword) and recorded noise (e.g. including different types and levels of noise). These files can be combined in a multitude of ways to form the training noise mix. In a user training example, the user can launch an app on a device such as a smart phone that is configured to prompt the user to utter and repeat a keyword or phrase. The app can further include or access a plurality of noise files, which are then combined with the user's recorded speech to form the training noisy mix.

In block 1006, speech enhancement is performed on the training noisy mix to produce an enhanced training mix. For example, the speech enhancement may be performed by a speech enhancement block that includes one or more of a noise suppressor or a beam-former or an acoustic echo canceler or an echo suppressor. In an OEM example, where the training is performed offline, the speech enhancement block can be included in a computer that is fed with the training noisy mix generated as described above. The speech enhancement block on the computer can include the exact same software and/or functionality that is included in the speech enhancement block of the target device that is used during runtime.

In block 1008, feature extraction may be performed on the enhanced training mix to extract a training signal feature of the training noisy mix. The extracted features may comprise one or both of temporal features or spectral features. Depending on whether training is performed offline or on the target device, this feature extraction is performed using a feature extraction block on an offline computer or on the target device.

In block 1010, a keyword model may be generated and/or optimized for the detecting the keyword using the features extracted from the training noisy mix. Block 1010 may also include performing label extraction to extract labels corresponding to the training speech and training noise. Depending on whether training is performed offline or on the target device, this keyword training is performed using a keyword training block on an offline computer (in which case the keyword model is thereafter loaded onto the target device) or a keyword training block on the target device.

Om block 1012, runtime noisy speech may be received from one or more microphones. The runtime noisy speech may include the keyword to be detected.

In block 1014, speech enhancement is performed on the runtime noisy speech to produce enhanced runtime speech. As in block 1006, for example, the speech enhancement may be performed by a speech enhancement block that includes one or more of a noise suppressor or a beam-former or an acoustic echo canceler or an echo suppressor.

In block 1016, feature extraction may be performed on the enhanced runtime noisy speech to extract a runtime signal feature of the runtime noisy speech. The extracted features are preferably the same features that are extracted during training in block 1008, and may comprise one or both of temporal features or spectral features.

At block 1018, the runtime signal feature may be provided to the keyword model for performing keyword detection on the enhanced runtime speech. Block 1018 may include detecting the keyword and generating a detection status based on the detection.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus comprising:
an integrated voice trigger module including:
a speech enhancement module, and
a keyword model that is configured for detecting a keyword,
wherein the integrated voice trigger module is configured to train the keyword model using enhanced training data during a training stage, the enhanced training data comprising training data after it has been processed by the speech enhancement module, and
wherein the integrated voice trigger module is further configured to use the keyword model for detecting the keyword using enhanced runtime speech during a runtime stage, the enhanced runtime speech comprising runtime speech after it has been processed by the speech enhancement module.

2. The apparatus of claim 1, wherein the speech enhancement module comprises a noise suppressor.

3. The apparatus of claim 2, wherein the training data includes clean speech mixed with noise.

4. The apparatus of claim 1, wherein the speech enhancement module comprises a beam-former.

5. The apparatus of claim 4, wherein the training data includes multi-channel speech data.

6. The apparatus of claim 1, wherein the speech enhancement module comprises an acoustic echo canceler or suppressor.

7. The apparatus of claim 6, wherein the training data includes clean speech mixed with echo.

8. The apparatus of claim 1,
wherein the integrated voice trigger module further includes a feature extraction block, and
wherein the feature extraction block is configured to extract a set of features from the enhanced training data that is provided to a model training block during the training stage, and
wherein the feature extraction block is configured to extract the set of features from the enhanced runtime data that is provided to the keyword model during the runtime stage.

9. The apparatus of claim 8,
wherein the integrated voice trigger module further includes a label extraction block, and
wherein the label extraction block is configured to extract labels from the training data, and
wherein the labels are provided to the model training block along with the extracted set of features during the training stage.

10. A method comprising:
configuring an integrated voice trigger module with a speech enhancement module, and a keyword model;
training the keyword model using enhanced training data during a training stage, the enhanced training data comprising training data after it has been processed by the speech enhancement module; and
using the keyword model to detect a keyword using enhanced runtime speech during a runtime stage, the enhanced runtime speech comprising runtime speech after it has been processed by the speech enhancement module.

11. The method of claim 10, wherein the speech enhancement module comprises a noise suppressor.

12. The method of claim 11, wherein the training data includes clean speech mixed with noise.

13. The method of claim 10, wherein the speech enhancement module comprises a beam-former.

14. The method of claim 13, wherein the training data includes multi-channel speech data.

15. The method of claim 10, wherein the speech enhancement module comprises an acoustic echo canceler or suppressor.

16. The method of claim 15, wherein the training data includes clean speech mixed with echo.

17. The method of claim 10, further comprising:
further configuring the integrated voice trigger module with a feature extraction block;
extracting, by the feature extraction block, a set of features from the enhanced training data that is provided to a model training block during the training stage; and
extracting, by the feature extraction block, the set of features from the enhanced runtime data that is provided to the keyword model during the runtime stage.

18. The method of claim 17, further comprising:
further configuring the integrated voice trigger module with a label extraction block;
extracting, by the label extraction block, labels from the training data during the training stage; and
providing the labels to the model training block along with the extracted set of features during the training stage.
